(19) United States
(12) Patent Application Publication
(10) Pub. No.: US 2020/0295580 A1
(43) Pub. Date: Sep. 17, 2020

(54) Modular Battery Pack

(71) Applicant: John Bishop, Santa Ana, CA (US)

(72) Inventor: John Bishop, Santa Ana, CA (US)

(21) Appl. No.: 16/352,786

(22) Filed: Mar. 13, 2019

(51) Int. Cl. H02J 7/00; H02J 7/02; H02J 50/12; H01M 2/10

(52) U.S. Cl. CPC H02J 7/0045; H02J 7/0021; H01M 2/1016; H02J 50/12; H02J 7/025

(57) ABSTRACT

A modular power storage device comprises a container configured to store one or more rechargeable batteries. The container is contemplated to receive an electric current via a conduit that taps a source of electricity to power the container and charge the contents therein. The rechargeable batteries are further contemplated to comprise any one or more additional features/functionalities.

### FIELD OF THE INVENTION

The field of the invention is modular energy storage systems.

### BACKGROUND

As electronic devices are increasingly tailored to mobile lifestyles, providing a means of recharging mobile devices is increasingly important. Importantly, the increasingly mobile technological space can be improved by providing mobile power sources that fit in with a mobile lifestyle. For example, power sources that can be divided into subcomponents, recovered, monetized, easily transported, and programmed to cooperate with existing mobile technologies enable users to more conveniently recharge any mobile devices.

In conventional modular battery pack systems, the use of multiple replaceable batteries in a battery pack serves maintenance-based functions. For example, replacement of failed batteries from a larger battery arrangement is simpler and more cost effective. However, the individual batteries cannot be separated to charge one or more rechargeable devices. In conventional modular battery pack systems each battery is limited to hardware elements that allow a battery pack to work in conjunction with other battery packs in the system. Each battery is not configured to be a separable unit with integrated input/output interfaces to directly charge and/or power electronic devices.

The prior art includes many battery packs in which the component batteries are charged together, and used together while in the pack but cannot, as a practical matter, be removed and used individually.

U.S. Pat. No. 8,860,250 to Salcone discloses a rolling battery pack containing batteries that are collectively charged and discharged together. Further, Salcone discloses that the battery is fully discharged or charged as a unit and each rechargeable battery cannot be removed and used individually.

U.S. Pat. No. 5,206,577 to Fish discloses a battery charger that dispenses charged batteries using a gravity feed-based mechanism. However, the battery charger in Fish simultaneously discharges and charges batteries coupled to the battery charger based on their placement in the battery charger. Further, the batteries in Fish are not configured to comprise additional modules enabling each battery to have additional functionality, including, for example, compatibility with universal charging standards (e.g., USB) and wireless communications capabilities.

U.S. Pat. No. 6,027,828 to Hahn teaches a stackable battery pack and accessories. However, Hahn fails to contemplate the use of battery packs that are compatible with modern computing devices with wireless capabilities, remote management of battery modules and systems, and wheeled containers used for charging, storing, and transporting multiple battery modules. Additionally, the invention contemplated in Hahn requires that each battery pack be connected directly to another to allow an electric current to flow between battery packs. Hahn does not contemplate the use of battery packs with parallel circuitry to allow each battery module to be charged without being in direct physical contact each other.

Salcone, Fish, Hahn, and all other extrinsic materials discussed herein are incorporated by reference to the same extent as if each individual extrinsic material was specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for modular battery systems with separable and individually usable battery packs. There is also a need for various hardware and software interfaces that allow each battery module to have enhanced functionality to interface with current technologies in present day electronic devices.

### SUMMARY OF THE INVENTION

The current state of mobile computing and other technological advancements allowing increasingly powerful and portable devices to become commonplace give rise to the challenges of keeping portable devices charged. For example, smartphones, laptops, and tablet computers have concentrated processing power, power hungry displays, and wireless connectivity that quickly saps them of battery life. To address the challenges created by present day mobile devices, improvements to portable power storage are necessary.

Among other things, the inventive subject matter provides apparatus, systems, and methods in which a portable energy storage device comprises a transportable container with multiple cavities adapted to receive one or more portable battery packs. It is further contemplated that the container includes an electrical conduit, including, for example, a type A plug. A portable battery packs can removably couple with the cavity to be charged via wired and/or wireless charging.

Various resources, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a functional block diagram illustrating a distributed data processing environment.

FIG. 2 is a perspective view of a battery pack.

FIGS. 3A, 3B, and 3C depict alternative embodiments of a battery pack with various input/output interfaces.

FIG. 4 depicts a bottom-up perspective view of a battery pack.

FIG. 5 depicts a cross sectional view of an upper electrical conduit with a magnetic actuator connected to two connecting prongs.

FIG. 6 depicts a cross sectional view of a lower magnetic activation element that has an opposite polarity to the magnetic actuator depicted in FIG. 5.

FIG. 7 depicts various views of one embodiment of a top plate and a bottom place comprising a battery pack.

FIG. 8 illustrates how two battery packs physically engage with each other to establish an electrical connection.

FIGS. 9A and 9B depict perspective views of a mobile charging station configured to house multiple battery packs.

FIGS. 10A and 10B depicts rear perspective views of the mobile charging station.

FIG. 11A depicts how battery packs engage with slots in the mobile charging station and wireless connectivity integrated into the mobile charging station.

FIG. 11B depicts a user interface of a computing device receiving updates regarding a status of a battery pack.

FIG. 12 illustrates how the mobile charging station can be transported by a user.

FIG. 13 depicts a block diagram of components of the server computer executing the battery management engine within the distributed data processing environment of FIG. 1.

### DETAILED DESCRIPTION

It should be noted that while the following description is drawn to a computer-based scheduling system, various alternative configurations are also deemed suitable and may employ various computing devices including servers, interfaces, systems, databases, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclose apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including facilitating the movement of driverless and non-driverless vehicles, establishing priorities/precedence among multiple vehicles, and allowing communication between vehicles.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

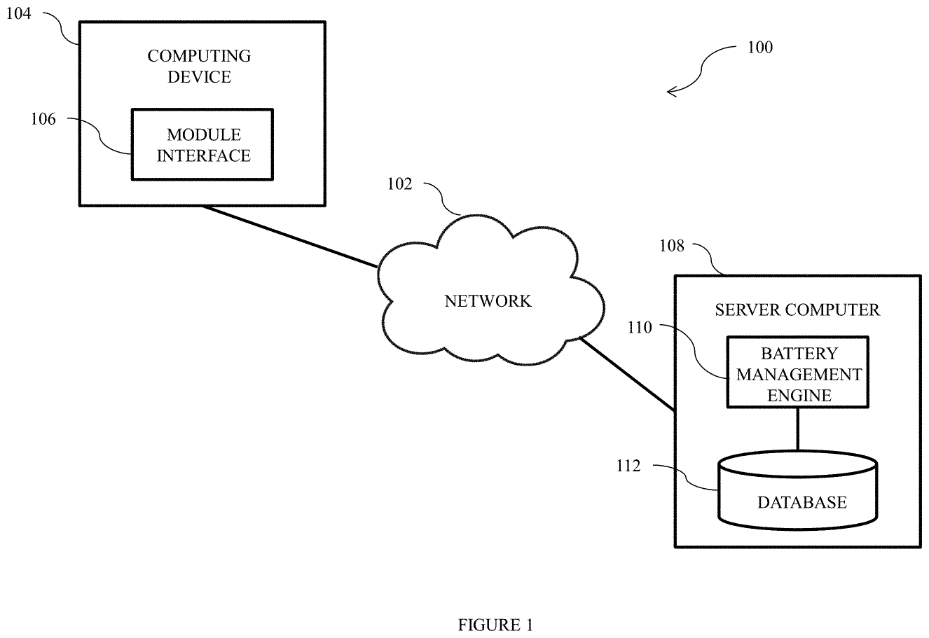

FIG. 1 is a functional block diagram illustrating a distributed data processing environment.

The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes computing device 104 and server computer 108, interconnected over network 102. Network 102 can include, for example, a telecommunications network, a local area network (LAN), a wide area network (WAN), such as the Internet, or a combination of the three, and can include wired, wireless, or fiber optic connections. Network 102 can include one or more wired and/or wireless networks that are capable of receiving and transmitting data, voice, and/or video signals, including multimedia signals that include voice, data, and video information. In general, network 102 can be any combination of connections and protocols that will support communications between computing device 104, server computer 108, and any other computing devices (not shown) within distributed data processing environment 100.

It is contemplated that computing device 104 can be any programmable electronic computing device capable of communicating with various components and devices within distributed data processing environment 100, via network 102. It is further contemplated that computing device 104 can execute machine readable program instructions and communicate with any devices capable of communication wirelessly and/or through a wired connection. Computing device 104 includes an instance of module interface 106.

Module interface 106 provides a user interface to battery management engine 110. Preferably, module interface 106 comprises a graphical user interface (GUI) or a web user interface (WUI) that can display one or more of text, documents, web browser windows, user option, application interfaces, and operational instructions. It is also contemplated that user interface can include information, such as, for example, graphics, texts, and sounds that a program presents to a user and the control sequences that allow a user to control a program.

In some embodiments, user interface can be mobile application software. Mobile application software, or an “app,” is a computer program designed to run on smart phones, tablet computers, and any other mobile devices.

Module interface 106 can allow a user to register with and configure battery management engine 110 (discussed in more detail below) to enable a driver controlling a non-driverless vehicle to participate in a driverless vehicle priority system. It is contemplated that module interface 106 can allow a user to provide any information to battery management engine 110. For example, a user can input authentication, battery management parameters, and any other information that is used by battery management engine 110. As used herein, “battery management parameters” comprise any variables that can directly or indirectly be associated with the battery. For example, battery management parameters can include special designations associated with a user that affect how batteries are charged, monetized, and discharged.

Server computer 108 can be a standalone computing device, a management server, a web server, a mobile computing device, or any other computing system capable of receiving, sending, and processing data.

It is contemplated that server computer 108 can include a server computing system that utilizes multiple computers as a server system, such as, for example, a cloud computing system.

In other embodiments, server computer 108 can be a computer system utilizing clustered computers and components that act as a single pool of seamless resources when accessed within distributed data processing environment 100.

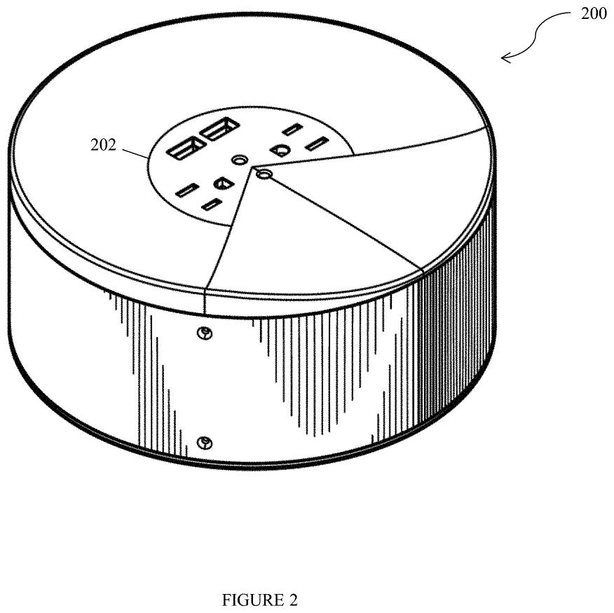

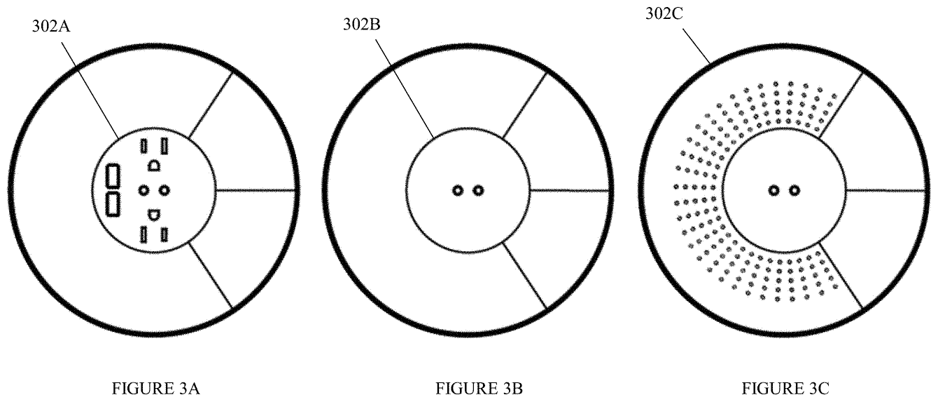

Battery management engine 110 is depicted and described in more detail in FIG. 2 and FIG. 3.

Database 112 is a repository for data used by battery management engine 110. In the depicted embodiment, battery management engine 110 resides on server computer 108. However, database 112 can reside anywhere within a distributed data processing environment provided that battery management engine 110 has access to database 112.

Data storage can be implemented with any type of data storage device capable of storing data and configuration files that can be accessed and utilized by server computer 108. Data storage devices can include, but are not limited to, database servers, hard disk drives, flash memory, and any combination thereof.

FIG. 2 is a perspective view of battery pack 200.

As depicted, battery pack 200 is a cylindrical apparatus. However, battery pack 200, as depicted, is merely illustrative. In other embodiments, battery pack 200 can be any physical structure adapted to receive a charge and distribute a charge. For example, battery pack 200 can be shaped as a rectangular prism, sphere, hemisphere, or any other three-dimensional shapes. It is further contemplated that battery pack 200 is configured to cooperatively couple to other battery packs 200. For example, battery packs 200 can cooperatively couple to each other in any one or more of connections comprising physical, electrical, and wireless communications-based connections.

FIGS. 3A, 3B, and 3C depict alternative embodiments of battery pack 200 with first, second, and third input/output (I/O) interfaces 302A, 302B, and 302C, respectively.

First I/O interface 302A includes two three prong power outlets, two USB connections, and one pair of electrical contacts configured to allow battery pack 200 to receive an electrical charge. As used herein, USB connections can be any universal serial bus interface that allows an electricity to be delivered through a conduit to an electronic device. For example, USB connections can include, but are not limited to, USB-A, USB-B, USB-C, mini-USB, and micro-USB. In some cases, USB connections can also include any connections that are used to charge a rechargeable electronic device. It is further contemplated that first I/O interface 302A can comprise prong power outlets that conform to any standard. For example, first I/O interface 302A can comprise a mixture of a 120 volt outlet and a 240 volt outlet.

Second I/O interface 302B includes one pair of electrical contacts configured to allow battery pack 200 to receive an electrical charge. Third I/O interface 302C includes one pair of electrical contacts as well as a speaker. However, it is contemplated that first, second, and third interfaces 302A, 302B, and 302C can comprise any electronic components, including, for example, displays and sensors.

In some embodiments, battery pack 200 comprises one or more wireless communication devices for receiving and/or transmitting data. Wireless communication devices can include, but are not limited to, Bluetooth transmitters/receivers, cellular data communications transmitters/receivers, wireless fidelity-based transmitters/receivers, and near field communications technologies. In one example, battery pack 200 can include a subscriber identification module (SIM) card that allows a user to connect to a cellular data network by proxy of battery pack 200.

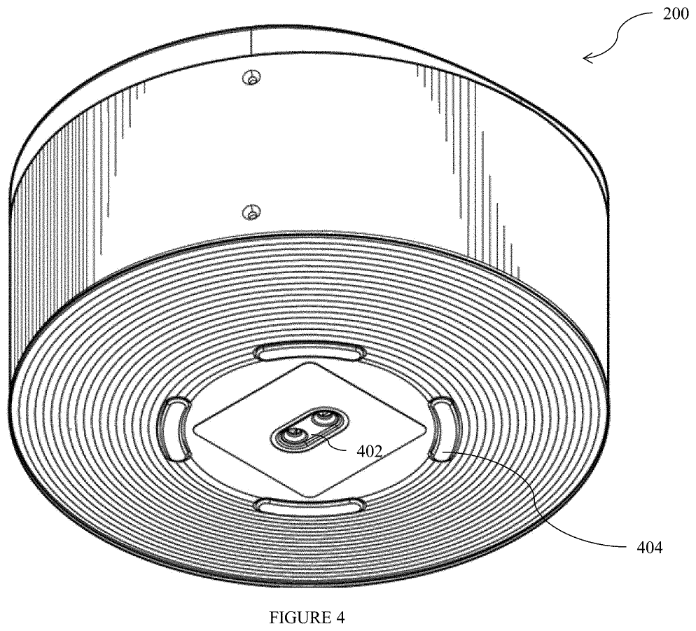

FIG. 4 depicts a bottom-up perspective view of battery pack 200.

Battery pack 200 further comprises electrical contacts 402 and feet 404. It is contemplated that electrical contacts 402 are adapted to cooperatively couple with another pair or electrical contact to create a conduit for electricity to flow between multiple connected battery packs 200.

It is contemplated that electrical contacts 402 provide a conduit for electricity to recharge a rechargeable battery. It is further contemplated that a rechargeable battery coupled to battery pack 200 can comprise any material capable of storing and releasing energy at a later time. For example, the rechargeable battery can include, but is not limited to, nickel cadmium batteries, nickel metal hydride batteries, lithium ion batteries, and lead acid batteries.

In some embodiments, electrical contacts 402 comprises indirect charging mechanisms, including devices coupled to battery pack 200 to wirelessly recharge and rechargeable battery. For example, electrical contacts 402 can include an induction coil to receive power from an electromagnetic field, which is then converted to electric current to charge a rechargeable battery. In another example, electrical contacts 402 can include an induction coil configured to be used in a resonant inductive coupling mechanism to enable charging between sender and receiver coils over longer distances.

As depicted, feet 404 are elevated platforms extending from the bottom surface of battery pack 200. It is contemplated that feet 404 can comprise additional resilient materials to prevent lateral movement and/or provide dampening effects when placed on a surface.

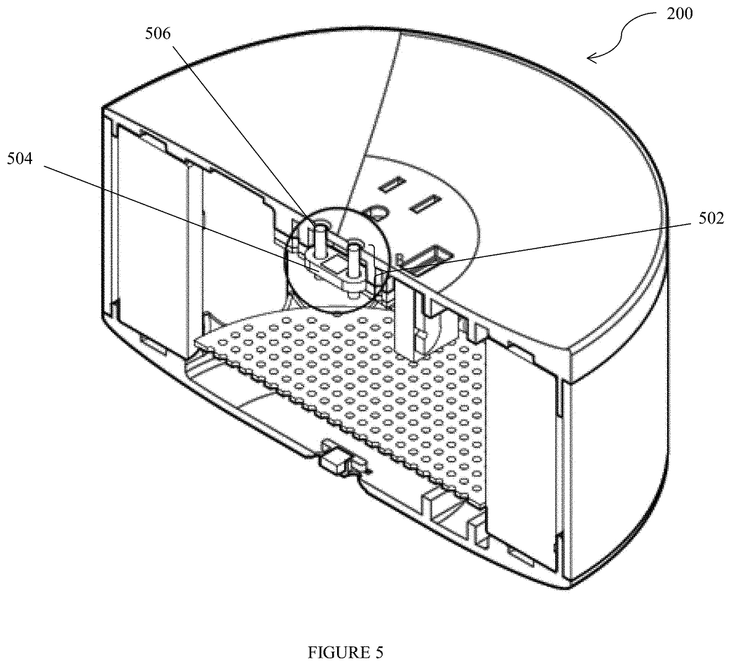

FIG. 5 depicts a cross sectional view of an upper electrical conduit with magnetic actuator 504 connected to prongs 506.

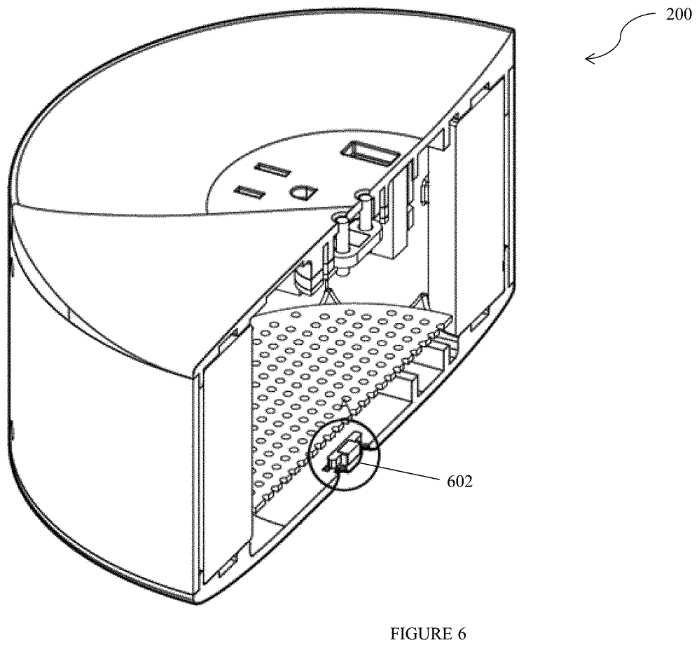

In the depicted embodiment, magnetic actuator 504 comprises a magnet that has an opposite polarity to magnet 602, which is discussed in further detail in FIG. 6. For example, magnetic actuator 504 can have a magnetic polarity aligned with a north pole, which can cause movement of magnetic actuator 504 towards a magnet having a magnetic polarity aligned with a south pole.

Magnetic actuator 504 is further coupled with prongs 506, such that movement of magnetic actuator 504 to a different position causes the corresponding movement of prongs 506. For example, if magnetic actuator 504 is attracted to a magnet of opposite polarity, magnetic actuator 504 can cause prongs 506 to be moved towards the magnet of opposite polarity, thereby causing prongs 506 to protrude outside the surface of battery pack 200.

In alternative embodiments, magnetic actuator 504 and prongs 506 are replaced by an induction charging element. For example, battery pack 200 can include an induction coil in lieu of magnetic actuator 504 and prongs 506 to allow battery pack 200 to be recharged wirelessly. In other examples, battery pack 200 can use magnetic actuator 504 to close an electrical circuit to an induction-based charging element to allow inductive charging.

FIG. 6 depicts a cross sectional view of magnet 602 that has an opposite polarity to magnetic actuator 504 depicted in FIG. 5.

It is contemplated that magnet 602 has an opposite polarity relative to magnetic actuator 504. By using attractive forces provided by magnets of opposing polarities, magnet 602 can cause physical movement of magnetic actuator 504 to enable recharging of a rechargeable battery coupled to battery pack 200.

In one embodiment, magnet 602 causes prongs 506 to protrude outside of battery pack 200 and cause physical contact with electrical contacts 402. In another embodiment, magnet 602 causes magnetic actuator 504 to close an electrical circuit to an inductive charging coil to enable wireless charging of battery pack 200.

In alternative embodiments, battery pack 200 does not include magnet 602. For example, battery pack 200 can include an inductive charging mechanism that does not require any physical movement of components to initiate energy transfer.

As disclosed herein, inductive charging mechanisms include electromagnetic resonance technology, which enables wireless charging over longer distances than convention inductive charging.

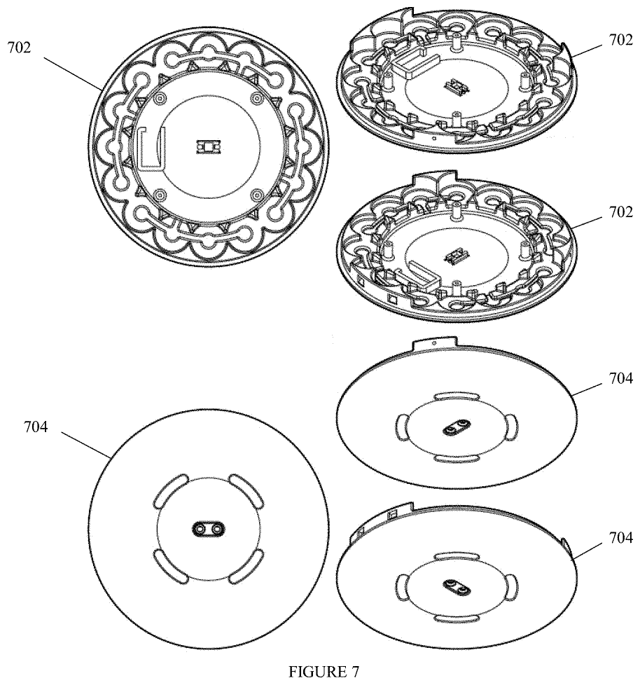

FIG. 7 depicts various views of one embodiment of a top plate and a bottom place comprising a battery pack.

As depicted the top plate and bottom plate of battery pack 200 are configured to couple with a cylindrical body defining a lumen. In one embodiment, the top plate and bottom plate of battery pack 200 are configured to receive and secure battery cells. For example, the top plate and bottom plate of battery pack 200 can be configured to partially receive the top and bottom portions of each Nickel-Cadmium battery cell within to secure it within the lumen of the cylindrical body disposed between the top and bottom cells.

In other embodiments, the top and bottom plates of battery pack have corresponding securing mechanisms for custom battery packs. For example, a custom battery pack can include a lithium ion battery pack that is sized and dimensioned to fit within the lumen of battery pack 200 without separable battery cells.

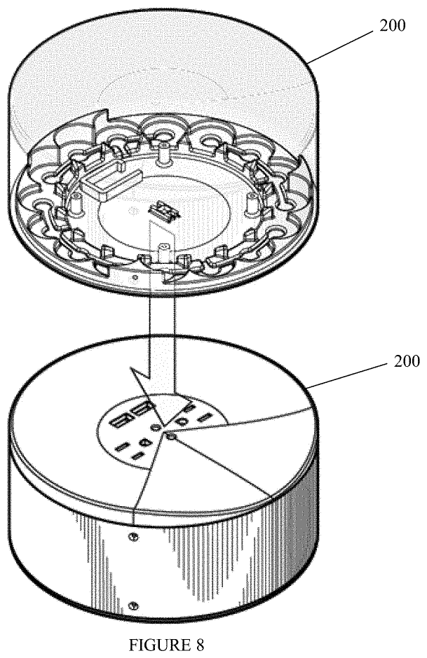

FIG. 8 illustrates how two battery packs physically engage with each other to establish an electrical connection.

In embodiments where battery pack 200 uses wireless charging mechanisms, a physical connection between two battery packs is not required.

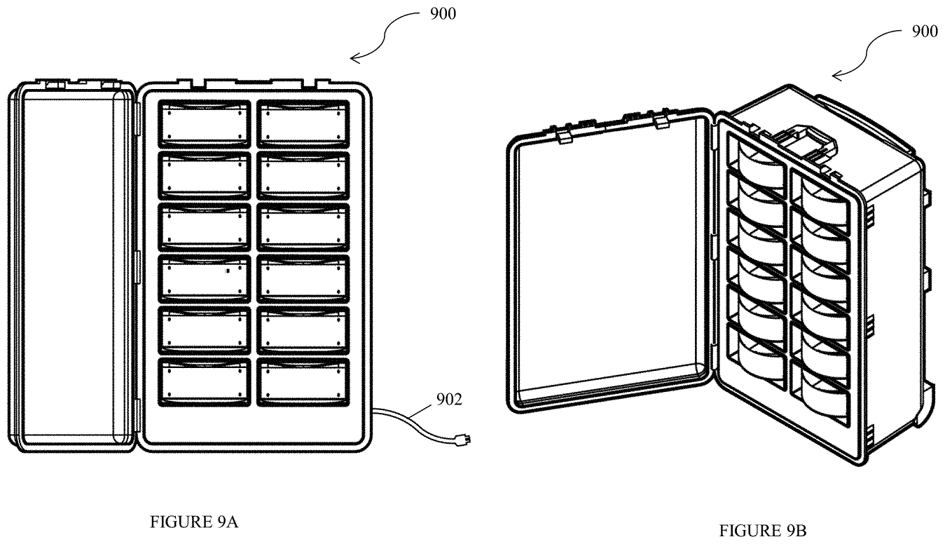

FIGS. 9A and 9B depict perspective views of mobile charging station 900 configured to house multiple battery packs. Mobile charging station 900 also comprises electrical conduit 902 to tap a source of electricity.

As depicted, mobile charging station 900 houses twelve battery pack, but it is contemplated that mobile charging station 900 can be configured to house any number of battery packs.

It is contemplated that electrical conduit 902 can deliver electricity to recharge multiple battery packs housed within mobile charging station 900. Additionally, it is further contemplated that electrical conduit 902 can deliver power to various electronic components coupled to mobile charging station 900. For example, electrical conduit 902 can deliver power to operate one or more computer processors, screens, and sensors coupled to mobile charging station 900.

In some embodiments, electrical conduit 902 is a retractable power conduit that can be substantially housed in the body of mobile charging station 900.

In situations where only some of the slots for battery packs 200 are occupied, mobile charging station 900 is contemplated to be capable of charging non-adjacent battery packs substantially simultaneously. For example, the electrical circuitry in mobile charging station 900 can be configured in parallel such that removal of one battery pack does not open the electrical charging circuit, thereby causing one or more of battery packs 200 occupying mobile charging station 900 to not receive a charge.

It is further contemplated that the slots adapted to receive one or more battery packs 200 can be in any configuration. For example, the slots in mobile charging station 900 can be positioned such that the slots create a herringbone pattern to maximize the number of battery packs 200 that mobile charging station 900 can accommodate.

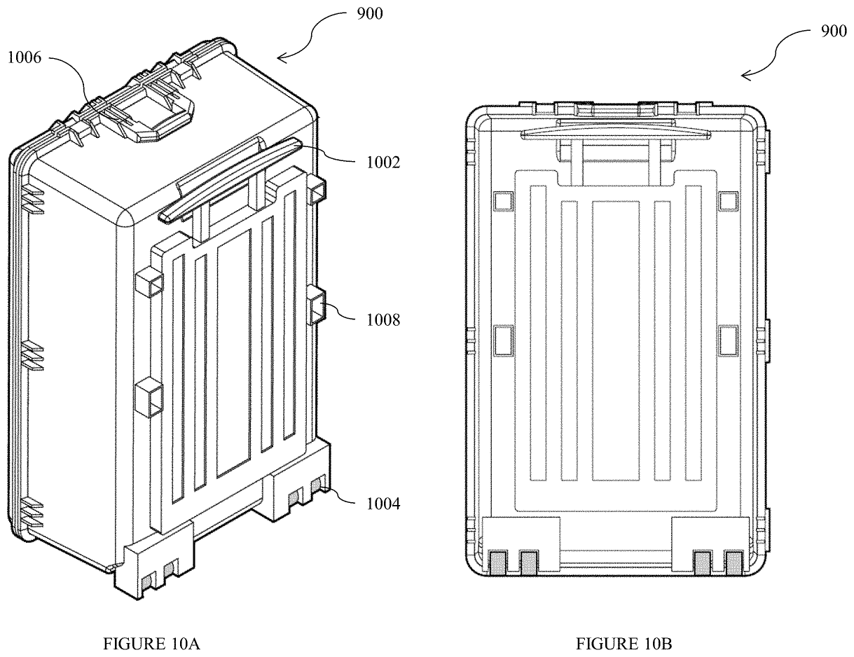

FIGS. 10A and 10B depicts rear perspective views of mobile charging station 900.

It is contemplated that mobile charging station 900 further comprised telescoping handle 1002, wheels 1004, top handle 1006, and external electrical conduits 1008. In alternative embodiments, mobile charging station 900 does not roll and is, instead, configured to be substantially stationary.

Telescoping handle 1002 extends to allow a user to pull the mobile charging station 900 to facilitate transport. For example, telescoping handle 1002 allows mobile charging station 900 to be rolled using wheels 1004.

It is contemplated that wheels 1004 can be any device facilitating movement. In a preferred example, wheels 1004 can be two unidirectional wheels positioned on a side of mobile charging station 900 closest to the telescoping handle. In another example, wheels 1004 can be 360° spinning wheels that allow mobile charging station to be moved in any lateral direction.

In some embodiments, wheels 1004 are not conventional wheels, including, for example, any structure that can be used to facilitate movement on unconventional surfaces. For example, wheels 104 can be a series of rollers connected to treads that allow mobile charging station 900 to traverse rough terrain, including, for example, unpaved and rocky surfaces. In another example, wheels 1004 can be ski-shaped feet to allow transport of mobile charging station 900 on snowy terrain.

External electrical conduits 1008 are contemplated to allow multiple mobile charging stations 900 to connect together and allow electricity to flow between the multiple mobile charging stations 900. In preferred embodiments, external electrical conduits 1008 allow stacking of mobile charging stations 900 to allow charging of all mobile charging stations 900 substantially simultaneously.

In some embodiments, external electrical conduits 1008 do not conduct electricity and are, instead, used to facilitate storage of multiple mobile charging stations 900. For example, external electrical conduits 1008 can be sized and dimensioned to mate with a corresponding structure on another mobile charging station 900 without allowing electricity to move between stacked mobile charging stations 900.

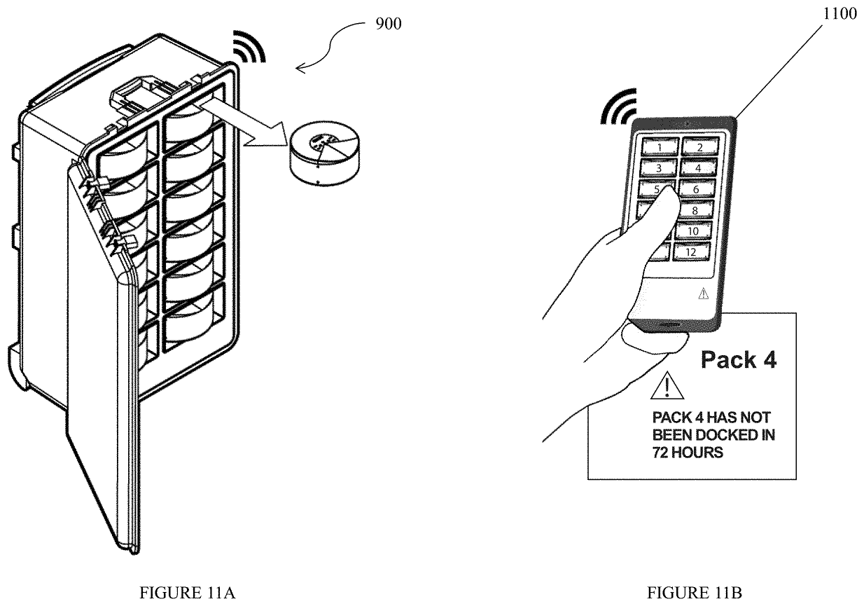

FIG. 11A depicts how battery packs engage with slots in the mobile charging station 900 and wireless connectivity integrated into the mobile charging station.

It is contemplated that mobile charging station 900 can comprise any one or more devices allowing any type of wireless connectivity. For example, mobile charging station 900 can comprise wireless connection devices including, but not limited to, Bluetooth transmitters/receivers, wireless fidelity-based transmitters/receivers, and near-field communications technologies.

In preferred embodiments, mobile charging station 900 transmits data to an external device to provide data associated with the status of battery packs 200 stored within. For example, mobile charging station 900 can transmit data regarding the charge status of each battery pack 200.

In other embodiments, mobile charging station 900 transmits data regarding battery packs 200 that have been taken out of mobile charging station 900. For example, mobile charging station 900 can transmit data to a smart phone regarding which battery packs 200 have been removed from storage, the amount of charge left on the removed battery packs, and an amount to be charged for the time and/or amount of battery used by a user.

In yet other embodiments, mobile charging station 900 transmits data regarding the health of the battery packs. For example, mobile charging station 900 can determine the health of the battery packs based on charging characteristics and number of recharge cycles associated with each battery. Following a determination of battery health, mobile charging station 900 can relay the information to any one or more computing devices.

FIG. 11B depicts a user interface of a computing device receiving updates regarding a status of a battery pack.

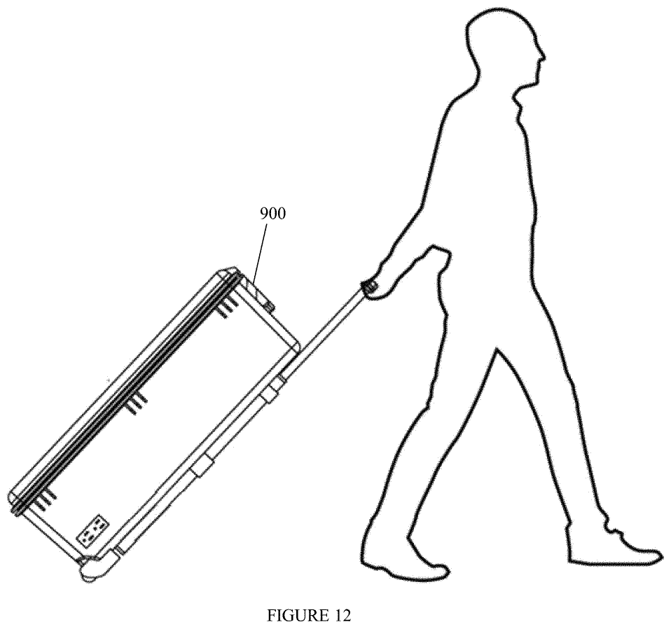

FIG. 12 illustrates how mobile charging station 900 can be transported by a user.

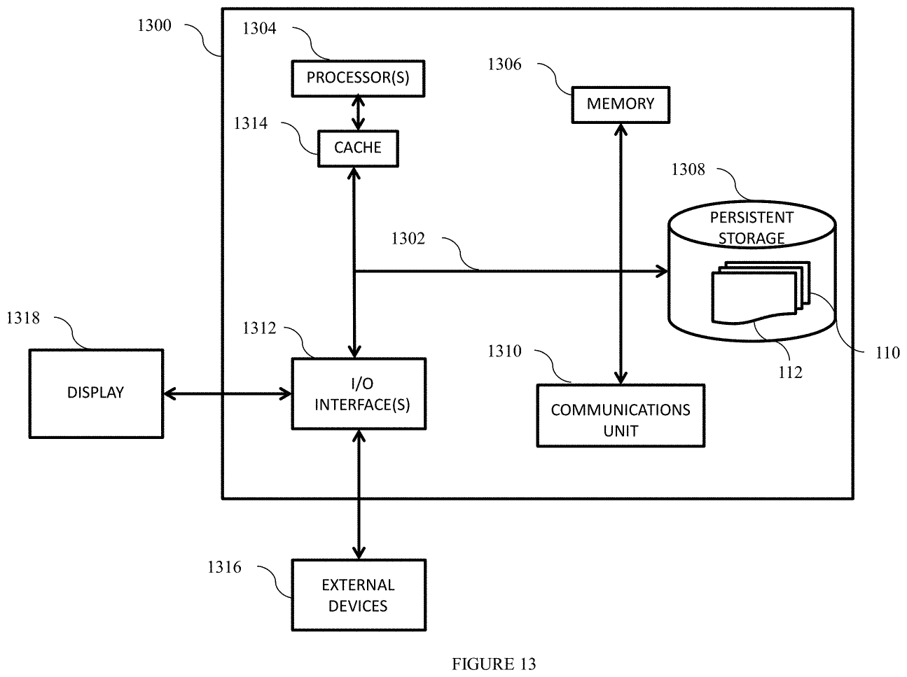

FIG. 13 depicts a block diagram of components of the server computer executing the battery management engine within the distributed data processing environment of FIG. 1. FIG. 13 is not limited to the depicted embodiment. Any modification known in the art can be made to the depicted embodiment.

In one embodiment, the computer includes processor(s) 1304, cache 1314, memory 1306, persistent storage 1308, communications unit 1310, input/output (I/O) interface(s) 1312, and communications fabric 1302.

Communications fabric 1302 provides a communication medium between cache 1314, memory 1306, persistent storage 1308, communications unit 1310, and I/O interface 1312. Communications fabric 1302 can include any means of moving data and/or control information between computer processors, system memory, peripheral devices, and any other hardware components.

Memory 1306 and persistent storage 1308 are computer readable storage media. As depicted, memory 1306 can include any volatile or non-volatile computer storage media. For example, volatile memory can include dynamic random access memory and/or static random access memory. In another example, non-volatile memory can include hard disk drives, solid state drives, semiconductor storage devices, a read-only memory (ROM), an erasable programmable read-only memory (EPROM), a flash memory, and any other storage medium that does not require a constant source of power to retain data.

In one embodiment, memory 1306 and persistent storage 1308 are random access memory and a hard drive hardwired to computing device 104, respectively. For example, computing device 104 can be a computer executing the program instructions of battery management engine 110 communicatively coupled to a solid state drive and DRAM.

In some embodiments, persistent storage 1308 is removable. For example, persistent storage 1308 can be a thumb drive or a card with embedded integrated circuits.

Communications unit 1310 provides a medium for communicating with other data processing systems or devices, including data resources used by computing device 104. For example, communications unit 1310 can comprise multiple network interface cards. In another example, communications unit 1310 can comprise physical and/or wireless communication links.

It is contemplated that battery management engine 110, database 112, and any other programs can be downloaded to persistent storage 1308 using communications unit 1310.

In a preferred embodiment, communications unit 1310 comprises a global positioning satellite (GPS) device, a cellular data network communications device, and short to intermediate distance communications device (e.g., Bluetooth®, near-field communications, etc.). It is contemplated that communications unit 1310 allows computing device 104 to communicate with other computing devices 104 associated with other users.

Display 1318 is contemplated to provide a mechanism to display information from battery management engine 110 through computing device 104. In preferred embodiments, display 1318 can have additional functionalities. For example, display 1318 can be a pressure-based touch screen or a capacitive touch screen.

In yet other embodiments, display 1318 can be any combination of sensory output devices, such as, for example, a speaker that communicates information to a user and/or a vibration/haptic feedback mechanism. For example, display 1318 can be a combination of a touchscreen in the dashboard of a car, a voice command-based communication system, and a vibrating bracelet worn by a user to communicate information through a series of vibrations.

It is contemplated that display 1318 does not need to be physically hardwired components and can, instead, be a collection of different devices that cooperatively communicate information to a user.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something designated from the group consisting of A, B, C . . . and N, the text should be interpreted as requiring only one element from the group, not A plus N, or B plus N, etc.

What is claimed is:

1. A modular power storage device, comprising:
first and second physically separable, rechargeable batteries;
a container comprising a cavity configured to removably receive the first and second rechargeable batteries;
an electrical conduit configured to supply power to the first and second rechargeable batteries through a connector of the container; and
the container has power output connectors so that the container can be used as a power source.

2. The device of claim 1, wherein the power output connectors are configured to mate with power input connectors of a second container to deliver power.

3. The device of claim 1, wherein the container further comprises a telescoping handle.

4. The device of claim 1, wherein the container further comprises a wheel.

5. The device of claim 1, wherein the container further comprises a wireless communications module configured to receive and transmit data.

6. The device of claim 1, wherein the first and second rechargeable batteries each comprise wireless communication modules configured to receive and transmit data.

7. The device of claim 1, wherein the rechargeable battery further comprises a speaker.

8. The device of claim 1, wherein the rechargeable battery receives the electric charge using physical electrical contacts.

9. The device of claim 8, wherein the physical electrical contacts are moved from substantially within a surface of the rechargeable battery to at least partially outside the surface of the rechargeable battery pack using a magnetic actuator.

10. The device of claim 1, wherein the rechargeable battery receives the electric charge through induction by using at least one induction coil.
